(19) United States
(12) Patent Application Publication
(10) Pub. No.: US 2010/0192364 A1
(43) Pub. Date: Aug. 5, 2010

(54) PROCESS FOR MANUFACTURING SECONDARY BATTERY

(75) Inventors: Toshitsugu SUZUKI, Tokyo (JP); Yasuhiko TAKAMUKI, Tokyo (JP); Takeo ARAI, Tokyo (JP)

Correspondence Address: CANTOR COLBURN, LLP, 20 Church Street, 22nd Floor, Hartford, CT, 06103, US

(73) Assignee: KONICA MINOLTA HOLDINGS, INC., Tokyo (JP)

(21) Appl. No.: 12/694,654

(22) Filed: Jan. 27, 2010

(30) Foreign Application Priority Data
Feb. 2, 2009 (JP) 2009-021376

(51) Int. Cl. H01M 10/04

(52) U.S. Cl. 29/623.5

(57) ABSTRACT

Disclosed is a process for manufacturing a secondary battery comprising a positive electrode, a negative electrode and a solid electrolyte layer, the solid electrolyte layer being interposed between a positive electrode active material layer of the positive electrode and a negative electrode active material layer of the negative electrode, the process comprising the steps of heat-melting a solid electrolyte, coating the heat-melted solid electrolyte on a first layer which is one layer of the positive electrode active material layer and the negative electrode active material layer, thereby forming a solid electrolyte layer, and combining the solid electrolyte layer with a second layer which is the other layer of the positive electrode active material layer and the negative electrode active material layer, through a heated liquid.

This application is based on Japanese Patent Application No. 2009-021376, filed on Feb. 2, 2009 in Japanese Patent Office, the entire content of which is hereby incorporated by reference.

### FIELD OF THE INVENTION

The present invention relates to a process for manufacturing a secondary battery having excellent repeated charge/discharge cycle property at high productivity.

### TECHNICAL BACKGROUND

A battery employing a solid electrolyte in place of an electrolyte solution has many advantages that high safety is secured without liquid leakage occurring in a battery employing an electrolyte solution, a process of applying an electrolyte solution is not required, and an expensive separator is not required. As a process for manufacturing a battery employing a solid electrolyte, a process is disclosed which comprises the steps of coating a heat-melted electrolyte on an active material layer of an electrode and combining a positive electrode with a negative electrode while applying heat to metal foils of the positive electrode and the negative electrode employing heated rollers (for example, WO 02/19450).

However, in the above method, heat is applied to the metal foils of both electrodes so that both electrodes combine with each other, and then cooled. While heated and cooled, strain due to shrinkage or heat expansion occurs in an interface between the metal foil as a current collector and the active material layer in the battery, lowers adhesion between the metal foil as a current collector and the active material layer, and reduces the battery capacity after charge/discharge cycle is repeated.

### SUMMARY OF THE INVENTION

The present invention has been made in view of the above. An object of the invention is to provide a process for manufacturing a secondary battery having excellent repeated charge/discharge cycle property and high capacity at high productivity. The present invention is a process for manufacturing a secondary battery comprising a positive electrode, a negative electrode and a solid electrolyte layer, the solid electrolyte layer being interposed between a positive electrode active material layer of the positive electrode and a negative electrode active material layer of the negative electrode, the process comprising the steps of heat-melting a solid electrolyte, coating the heat-melted solid electrolyte on a first layer which is one layer of the positive electrode active material layer and the negative electrode active material layer, thereby forming a solid electrolyte layer, and combining the solid electrolyte layer with a second layer which is the other layer of the positive electrode active material layer and the negative electrode active material layer, through a heated liquid.

### BRIEF EXPLANATION OF THE DRAWINGS

FIG. 1 is a schematic view showing a first embodiment of the secondary battery manufacturing process of the invention.

FIG. 2 is a schematic view showing a second embodiment of the secondary battery manufacturing process of the invention.

FIG. 3 is a schematic view showing a third embodiment of the secondary battery manufacturing process of the invention.

FIG. 4 is a schematic view showing a fourth embodiment of the secondary battery manufacturing process of the invention.

FIG. 5 is a schematic view showing a comparative secondary battery manufacturing process.

### DETAILED DESCRIPTION OF THE INVENTION

The above object of the invention can be attained by any one of the following constitutions.

1. A process for manufacturing a secondary battery comprising a positive electrode, a negative electrode and a solid electrolyte layer, the positive electrode comprising a first current collector and provided thereon, a positive electrode active material layer containing a positive electrode active material, the negative electrode comprising a second current collector and provided thereon, a negative electrode active material layer containing a negative electrode active material, and the solid electrolyte layer being interposed between the positive electrode active material layer and the negative electrode active material layer, the process comprising the steps of heat-melting a solid electrolyte, coating the heat-melted solid electrolyte on a first layer which is one layer of the positive electrode active material layer of the positive electrode and the negative electrode active material layer of the negative electrode, thereby forming a solid electrolyte layer, and combining the solid electrolyte layer with a second layer which is the other layer of the positive electrode active material layer of the positive electrode and the negative electrode active material layer of the negative electrode, through a heated liquid.

2. The process for manufacturing a secondary battery of item 1 above, wherein the heated liquid is coated on the second layer.

3. The process for manufacturing a secondary battery of item 1 or 2 above, wherein the coating amount of the heated liquid is from 1 to 50 g/m².

4. The process for manufacturing a secondary battery of any one of items 1 through 3 above, wherein the heated liquid is coated on the solid electrolyte layer.

5. The process for manufacturing a secondary battery of item 4 above, wherein the coating amount of the heated liquid is from 1 to 50 g/m².

6. The process for manufacturing a secondary battery of any one of items 1 through 5 above, wherein the solid electrolyte is heat-melted at 100 to 200° C., and the heated liquid is one heated at 100 to 200° C.

7. The process for manufacturing a secondary battery of any one of items 1 through 6 above, wherein the solid electrolyte layer contains a polymer compound, an organic solvent and a lithium salt.

8. The process for manufacturing a secondary battery of item 7 above, wherein the organic solvent contained in the solid electrolyte layer is the same as an organic solvent contained in the heated liquid.

9. The process for manufacturing a secondary battery of any one of items 1 through 8 above, wherein the positive electrode active material is selected from the group consisting of lithium manganese compound oxide (LiₓMn₂O₄), lithium nickel compound oxide (LiₓNiO₂), lithium cobalt compound oxide (LiₓCoO₂), lithium nickel cobalt compound oxide (LiₓNi_{1-y}Co_{y}O₂), spinel type lithium manganese nickel compound oxide (LiₓMn_{2-y}Ni_{y}O₄), lithium manganese cobalt compound oxide (LiₓMn_{y}Co_{1-y}O₂) and lithium iron phosphate (LiₓFePO₄), wherein x and y independently are in the range of from 0 to 1, and the negative electrode active material is a carbonaceous material selected from the group consisting of non-graphitizable carbon, graphitizable carbon, graphite, cracked carbon, cokes, glassy carbon, organic polymer compound calcined materials, carbon fiber and activated carbon.

10. The process for manufacturing a secondary battery of any one of items 1 through 9 above, wherein the first current collector comprises a metal foil and provided thereon, a resin layer, the resin layer being provided on the surface of the first current collector opposite the positive electrode active material layer, or wherein the second current collector comprises a metal foil and provided thereon, a resin layer, the resin layer being provided on the surface of the second current collector opposite the negative electrode active material layer.

11. A process for manufacturing a secondary battery comprising a positive electrode, a negative electrode and a solid electrolyte layer, the positive electrode comprising a first current collector and provided thereon, a positive electrode active material layer containing a positive electrode active material, the negative electrode comprising a second current collector and provided thereon, a negative electrode active material layer containing a negative electrode active material, and the solid electrolyte layer being interposed between the positive electrode active material layer and the negative electrode active material layer, the process comprising the steps of heat-melting a solid electrolyte, coating a first heated liquid on a first layer which is one layer of the positive electrode active material layer of the positive electrode and the negative electrode active material layer of the negative electrode, thereby forming a first heated liquid layer, coating a second heated liquid on a second layer which is the other layer of the positive electrode active material layer of the positive electrode and the negative electrode active material layer of the negative electrode, thereby forming a second heated liquid layer, coating the heat melted solid electrolyte on the first liquid layer, thereby forming an solid electrolyte layer, and combining the solid electrolyte layer with the second layer through the second heated liquid layer.

12. The process for manufacturing a secondary battery of item 11 above, wherein the coating amount of the first and second heated liquids is from 1 to 50 g/m².

13. The process for manufacturing a secondary battery of item 11 or 12 above, wherein the solid electrolyte is heat-melted at 100 to 200° C., and the first and second heated liquids are ones heated at 100 to 200° C.

14. The process for manufacturing a secondary battery of any one of items 11 through 13 above, wherein the solid electrolyte layer contains a polymer compound, an organic solvent and a lithium salt.

15. The process for manufacturing a secondary battery of item 14 above, wherein the organic solvent contained in the solid electrolyte layer is the same as an organic solvent contained in the second heated liquid.

16. The process for manufacturing a secondary battery of any one of items 11 through 15 above, wherein the positive electrode active material is selected from the group consisting of lithium manganese compound oxide (LiₓMn₂O₄), lithium nickel compound oxide (LiₓNiO₂), lithium cobalt compound oxide (LiₓCoO₂), lithium nickel cobalt compound oxide (LiₓNi_{1-y}Co_{y}O₂), spinel type lithium manganese nickel compound oxide (LiₓMn_{2-y}Ni_{y}O₄), lithium manganese cobalt compound oxide (LiₓMn_{y}Co_{1-y}O₂), or lithium iron phosphate (LiₓFePO₄), wherein x and y independently are in the range of from 0 to 1, and the negative electrode active material is a carbonaceous material selected from the group consisting of non-graphitizable carbon, graphitizable carbon, graphite, cracked carbon, cokes, glassy carbon, organic polymer compound calcined materials, carbon fiber and activated carbon.

17. The process for manufacturing a secondary battery of any one of items 11 through 16 above, wherein the first current collector comprises a metal foil and provided thereon, a resin layer, the resin layer being provided on the surface of the first current collector opposite the positive electrode active material layer, or wherein the second current collector comprises a metal foil and provided thereon, a resin layer, the resin layer being provided on the surface of the second current collector opposite the negative electrode active material layer.

The present invention relates to a process for manufacturing a secondary battery comprising a positive electrode, a negative electrode and a solid electrolyte layer, in which a heated liquid is applied to the surface of an active material layer of the two electrodes constituting the battery to soften the active material layer or to the solid electrolyte layer, followed by combining the two electrodes. The invention can provide a process for manufacturing a secondary battery having excellent repeated charge/discharge cycle property and high capacity at high productivity.

Next, the constituent elements and the preferred embodiments of the invention will be explained in detail.

### [Current Collector]

The current collector in the invention refers to a positive electrode current collector or a negative electrode current collector. As the current collector, there can be employed a plate or foil of a metal such as nickel, aluminum, copper, gold, silver, aluminum alloy or stainless steel; a mesh electrode or carbon electrode. Such a current collector may be provided with a catalyst effect or may be chemically combined with an active material.

In order to prevent the electrical contact between a positive electrode current collector and a negative electrode, an insulating layer composed of an insulating material such as a plastic resin may be provided between them.

In the invention, one of the first current collector and the second current collector constitutes a positive electrode and the other constitutes a negative electrode. However, the first current collector is different from the second current collector. For example, when the first collector constitutes a positive electrode, the second collector constitutes a negative electrode.

A metal foil-resin composite can be employed as a current collector, in which a resin layer is laminated on one surface of a metal foil. The metal foil-resin composite prevents the generation of wrinkles in the metal foil in the process of coating an active material layer on the metal foil and drying or of rolling the metal foil. Examples of a resin for the resin layer include polyethylene terephthalate, polyester, polyethylene naphthalate, polycarbonate, triacetylcellulose, and polyimide. A method for causing the metal foil and the resin layer to adhere to each other is not specifically limited, but is preferably one for causing them to adhere to each other through an adhesive. They may be strongly adhered to each other through an adhesive. Alternatively, they may be so loosely adhered to each other through an adhesive that they can be peeled from each other after manufacture. Further, the resin of the peeled resin layer is preferably recycled, in view of cost reduction and environmental concerns. The resin layer may be provided onto one surface or both surfaces of the metal foil. The thickness of the resin layer is preferably from 10 to 50 μm. Too high thickness of the resin layer deteriorates energy density relative to the size of a battery, while too low thickness of the resin layer deteriorates the strength of the metal foil, resulting in the generation of wrinkles.

### [Positive Electrode Active Material Layer]

The positive electrode active material layer contains a positive electrode active material, and preferably contains a positive electrode active material, an electrically conductive material and a binder. In order to mix these materials, a solvent is employed. The positive electrode active material layer may further contain an ionically conductive material or an electrolyte.

Typical examples of the positive electrode active material include manganese dioxide (MnO₂), iron oxide, copper oxide, nickel oxide, lithium manganese compound oxide (for example, LiₓMn₂O₄ or LiₓMnO₂), lithium nickel compound oxide (for example, LiₓNiO₂), lithium cobalt compound oxide (for example, LiₓCoO₂), lithium nickel cobalt compound oxide (for example, LiₓNi_{1-y}Co_{y}O₂), lithium manganese cobalt compound oxide (for example, LiMn_{y}CO_{1-y}O₂), spinel type lithium manganese nickel compound oxide (LiₓMn_{2-y}Ni_{y}O₄), lithium phosphor oxide (for example, LiₓFePO₄, LiₓFe_{1-y}Mn_{y}PO₄, LiₓCoPO₄) having an olivine structure, ferric sulfate (Fe₂(SO₄)₃), and vanadium oxide (for example, V₂O₅). In the above chemical formulas, x and y are preferably in the range of from 0 to 1. As the preferred positive electrode active material, there is mentioned lithium manganese compound oxide (LiₓMn₂O₄), lithium nickel compound oxide (LiₓNiO₂), lithium cobalt compound oxide (LiₓCoO₂), lithium nickel cobalt compound oxide (LiₓNi_{1-y}Co_{y}O₂), spinel type lithium manganese nickel compound oxide (LiₓMn_{2-y}Ni_{y}O₄), lithium manganese cobalt compound oxide (LiₓMn_{y}Co_{1-y}O₂), or lithium iron phosphate (LiₓFePO₄). In the above chemical formulas, x and y are preferably in the range of from 0 to 1. These positive electrode active materials are calcined under an oxidizing atmosphere to increase crystallinity and improve battery properties.

The electrically conductive material in the invention is not specifically limited as long as it can reduce impedance. Examples of the electrically conductive material include graphite, carbon black, acetylene black, carbonaceous particles such as vapor grown carbon fiber, particles of a metal such as copper, silver, gold or platinum, and an electrically conductive polymer such as polyaniline, polypyrrole, polythiophene, polyacetylene, or polyacene.

The binder in the invention is not specifically limited as long as it does not prevent the positive electrode active material and electrically conductive material from combining with the current collector. Examples of the binder include binder resins such as polyvinylidene fluoride, vinylidene fluoride-hexafluoropropylene copolymer, vinylidene fluoride-tetrafluoroethylene copolymer, styrene-butadiene copolymer rubber, polytetrafluoroethylene, polypropylene, polyethylene and polyimide.

The solvent in the invention is not specifically limited, and a conventional solvent is employed. The solvent is preferably one employed in a lithium ion battery, and examples thereof include acetonitrile, N-methylpyrrolidone, and N-pyrrolidone.

### [Negative Electrode Active Material Layer]

The negative electrode active material layer contains a negative electrode active material. The negative electrode active material is a negative electrode material capable of storing or releasing lithium. Examples of the negative electrode material capable of storing or releasing lithium include a carbonaceous material, a metal compound, an oxide, a sulfide, lithium nitride such as LiN₃, a lithium metal, a metal forming an alloy with lithium, and a polymer material. Among these, a carbonaceous material is preferably used as the negative electrode active material. When the carbonaceous material is insufficient in electron conductivity for current collection, addition of the electrically conductive material is preferred.

Examples of the carbonaceous materials include non-graphitizable carbon, graphitizable carbon, graphite, cracked carbon, cokes, glassy carbon, organic polymer compound calcined materials, carbon fiber and activated carbon. The cokes include pitch coke, needle coke, and petroleum coke. The organic polymer compound calcined material is a material obtained by claiming a polymer resin such as phenolic resin or furan resin at an appropriate temperature so as to be carbonated. Examples of the polymer materials include polyacetylene and polyacene.

Among these negative electrode materials capable of storing or releasing lithium, those having a charge/discharge potential relatively approximate to that of a lithium metal are preferred. Among these, the carbonaceous materials are preferred, which are extremely small in change of the crystal structure occurring during charging or discharging, and can provide high charge/discharge capacity and excellent cycle property. Graphite is especially preferred since it has high electrochemical equivalent and can give high energy density. Further, non-graphitizing carbon is preferred, since it can provide excellent cycle property.

Other examples of the negative electrode materials capable of storing or releasing lithium include a lithium metal, a metal element or metalloid element capable of forming an alloy with lithium, and an alloy or compound thereof. These materials are preferred since they can provide high energy density, and a combination of these materials and the carbonaceous materials is especially preferred since it can provide excellent cycle property as well as high energy density. The alloys in the invention include those composed of two or more kinds of metal elements and those composed of one or more kinds of metal elements and one or more kinds of metalloid elements. These alloys include as solid solutions, eutectics (eutectic mixtures), intermetallic compounds or a mixture thereof. Examples of the metal elements and metalloid elements include tin (Sn), lead (Pb), aluminum (Al), indium (In), Silicon (Si), antimony (Sb), bismuth (Bi), cadmium (Cd), magnesium (Mg), boron (B), Gallium (Ga), germanium (Ge), arsenic (As), silver (Ag), zirconium (Zr), Yttrium (Y) and hafnium (Hf). Among these, 4B-group metal elements and metalloid elements of short form periodic table, and alloy or compound thereof are preferred, and silicon (Si), tin (Sn) and alloy or compound thereof are especially preferred. These may be crystalline or amorphous. Besides the above, an inorganic compound containing no lithium, for example, MnO₂, V₂O₅, V₆O₁₃, NiS or MoS can be also employed.

The electrically conductive aids include acetylene black, ketjen black and non-crystalline carbon, and these may be used alone or as an admixture of two or more kinds thereof. Examples of the binder include polyvinylidene fluoride, carboxymethylcellulose and hydroxymethylcellulose, and these may be used alone or as an admixture of two or more kinds thereof.

### [Solid Electrolyte Layer]

The solid electrolyte in the invention transports charge carrier between both electrodes of the negative and positive electrodes. The solid electrolyte is a solid at room temperature, and has generally an ionic conductivity of from 10⁻⁵ to 10⁻¹ S/cm at room temperature. The solid electrolyte is melted by heat application to be liquid. The heating temperature for melting is preferably from 100 to 200° C., and more preferably from 120 to 170° C.

The solid electrolyte layer in the invention contains a polymer compound, an organic solvent and a lithium salt. The solid electrolyte layer may further contain inorganic oxide particle solid electrolyte carrying an ionically conductive compound.

Examples of the polymer compound include vinylidene fluoride polymers such as polyvinylidene fluoride, vinylidene fluoride-hexafluoropropylene copolymer, vinylidene fluoride-ethylene copolymer, vinylidene fluoride-monofluoroethylene copolymer, vinylidene fluoride-trifluoroethylene copolymer, vinylidene fluoride-tetrafluoroethylene copolymer, vinylidene fluoride-hexafluoropropylene-tetrafluoroethylene terpolymer; acrylonitrile polymers such as acrylonitrile-methyl methacrylate copolymer, acrylonitrile-methyl acrylate copolymer, acrylonitrile-ethyl methacrylate copolymer, acrylonitrile-ethyl acrylate copolymer, acrylonitrile-methacrylic acid copolymer, acrylonitrile-acrylic acid copolymer and acrylonitrile-vinyl acetate copolymer; and polymers such as polyethylene oxide, ethylene oxide-propylene oxide copolymer, and acrylates or methacrylates thereof.

The content of the polymer compound in the solid electrolyte layer is preferably from 10 to 50% by weight, and more preferably from 20 to 40% by weight.

As the organic solvent, an apotic organic solvent is employed. Examples of the apotic organic solvent include cyclic carbonates such as propylene carbonate (PC), ethylene carbonate (EC), butylene carbonate (BC) and vinylene carbonate (VC), straight-chained carbonates such as dimethyl carbonate (DMC), diethyl carbonate (DEC), ethyl methyl carbonate (EMC) and dipropyl carbonate (DPC), aliphatic carboxylic esters such as methyl formate, methyl acetate and ethyl propionate; γ-lactones such as γ-butyrolactone, straight-chained ethers such as 1,2-diethoxyethane and 1-ethoxy-1-methoxyethane, cyclic ethers such as tetrahydrofuran and 2-methyltetrahydrofuran, dimethylsulfoxide, 1,3-dioxolane, formamide, acetamide, dimethylformamide, dioxolane, acetonitrile, propylnitrile, nitromethane, ethyl monoglyme, phosphoric acid triester, trimethoxymethane, dioxolane derivatives, sulfolane, methyl sulfolane, 1,3-dimethyl-2-imidazolidinone, 3-methyl-2-oxazolidinone, propylene carbonate derivatives, tetrahydrofuran derivatives, ethyl ether, 1,3-propanesultone, anisole and N-methylpyrrolidone. These aprotic organic solvents may be used alone or as an admixture of two or more kinds thereof. The above-mentioned organic solvent, in which the lithium salt is dissolved, can be also used.

The content of the organic solvent in the solid electrolyte layer is preferably from 30 to 90% by weight, and more preferably from 50 to 80% by weight.

Examples of the lithium salt include LiPF₆, LiAsF₆, LiAlCl₄, LiClO₄, LiBF₄, LiSbF₆, LiCF₃SO₃, LiCF₃CO₂, Li(CF₃SO₂)₂, LiN(CF₃SO₂)₂, LiB₁₀Cl₁₀, lower aliphatic carboxylic acid lithium, chloroborane lithium, lithium tetraphenyl borate, LiBr, LiI, LiSCN, LiCl and imides.

The content of the lithium salt in the solid electrolyte layer is preferably from 1 to 20% by weight, and more preferably from 2 to 15% by weight.

The solid electrolytes disclosed in Japanese Patent Publication No. 6-511595 and WO 02-019450 can be suitably employed.

### [Inorganic Oxide Particle Solid Electrolyte Carrying an Ionically Conductive Compound]

The inorganic oxide particle solid electrolyte carrying an ionically conductive compound transports a charge carrier between both electrodes of the positive and negative electrodes, and generally has an ionic conductivity of from 10⁻⁵ to 10⁻¹ S/cm at room temperature. The inorganic oxide particles in the invention are superfine particles with high specific surface area and can carry on the surface many kinds of ionically conductive compounds. The superfine particles form a gel-like solid in a pseudo solid phase without containing a polymer such as an ionically conductive polymer or a flammable organic solvent. Accordingly, an electrolyte can be obtained, which is easy to handle and has high heat resistance since it does not contain a flammable liquid. Further, the electrolyte has good low temperature property since it does not contain a polymer.

The ionically conductive compounds are combined with the surface of the inorganic oxide particles through a group such as a silane group, a carbonyl group or a hydroxyl group capable of being covalently bonded to the inorganic oxide particles. Many kinds of these compounds are available on the market and can be synthesized according to an ordinary method and easily obtained. Specifically, an ionically conductive compound having a silane group is regarded as a silane coupling agent, and can be preferably employed due to the fact that the silane group is combined with the hydroxyl group on the surface of core/shell particles to form a stable covalent bond.

As a method of preparing a silane group-containing ionically conductive compound, there are mentioned various methods. For example, an ionically conductive compound, a silane coupling agent can be prepared by directly reacting a hydroxyl group-containing ionically conductive compound with an isocyanato group-containing isocyanato alkyl alkoxy silane to form a urethane bond from the hydroxyl group and the isocyanato group.

Further, employing the method disclosed in Japanese Patent O.P.I. Publication No. 2006-57093, the silane coupling agent can be also prepared as follows. An ionically conductive compound, a silane coupling agent can be prepared by reacting a hydroxyl group-containing ionically conductive compound with an aliphatic or alicyclic diisocyanate to obtain a monoisocyanato group-containing functional compound and then reacting the functional compound with an amino alkyl alkoxy silane.

A preparation method of the silane coupling agent which is an ionically conductive compound is not limited to the preparation method described above, but may be any known preparation method.

Examples of the ionically conductive compound include diethylene glycol, diethylene glycol monoethyl ether, diethylene glycol monomethyl ether, triethylene glycol, triethylene glycol monoethyl ether, triethylene glycol monomethyl ether, tetraethylene glycol, tetraethylene glycol monomethyl ether, tetraethylene glycol monoethyl ether, dipropylene glycol, dipropylene glycol monomethyl ether, dipropylene glycol monoethyl ether, and a homopolymer or copolymer of ethylene oxide, propylene oxide or butylene oxide each having a hydroxy group and a number average molecular weight of from 500 to 50,000. These exemplified compounds are ones having ionic conductivity.

Examples of the aliphatic or alicyclic diisocyanate include ethylene diisocyanate, methylene diisocyanate, hexamethylene diisocyanate, dodecamethylene diisocyanate, cyclobutane-1,3-diisocyanate, cyclohexane-1,3-diisocyanate, cyclohexane-1,4-diisocyanate, 1-isocyanato-3,3,5-trimethyl-5-isocyanatomethyl-cyclohexane, and an admixture thereof.

Examples of the amino alkoxy silane include 3-aminopropyltriethoxysilane, 3-aminopropyltrimethoxysilane, N-(2-aminoethyl)-3-aminopropyltrimethoxysilane, N-(2-aminoethyl)-3-aminopropylmethyldimethoxysilane, and 3-(N-phenyl)aminopropyltrimethoxysilane, which are available on the market.

Examples of the isocyanatoalkyl alkoxy silane include 3-isocyanatopropyltriethoxysilane and 3-isocyanatopropyl-trimethoxysilane, which are available on the market.

### [Adhesion Through Heated Liquid]

The heated liquid (hereinafter also referred to simply as the liquid in the invention) in the invention refers to one which is coated on the surface of an active material layer or a solid electrolyte layer, and elevating a temperature of the surface to soften the active material layer or the solid electrolyte layer, thereby enhancing adhesion between the positive electrode and the negative electrode when the positive electrode and the negative electrode are combined with each other. Therefore, the liquid in the invention is preferably a liquid at a temperature which causes the solid electrolyte layer surface or the active material layer surface to soften. Since the lithium ion battery has high voltage, the presence of a protic solvent or water may cause an electrolysis reaction in the process of charge or discharge to generate hydrogens. Accordingly, the liquid in the invention is preferably an aprotic solvent. Examples of the aprotic solvent include dimethylformamide, dimethylacetamide, dimethylsulfoxide, N-methyl-2-pyrrolidinone, N-formylpiperidine, propylene carbonate and ethylene carbonate. The liquid in the invention can contain the polymer compound, the organic solvent or the lithium salt contained in the solid electrolyte described above. In order to enhance the adhesion between the solid electrolyte layer and the active material layer, the organic solvent in the solid electrolyte are preferably the same as that in the heated liquid in the invention.

When the liquid in the invention is heat-coated, the heating temperature of the liquid is preferably from 100 to 200° C. Too high a heating temperature may cause evaporation or decomposition of the liquid. Too low a heating temperature cannot sufficiently soften the surface of the active material layer and cannot enhance the adhesion between the electrolyte layer and the active material layer.

The coating amount of the heated liquid is preferably from 1 to 50 g/m², and more preferably from 3 to 20 g/m². When the coating amount of the liquid is too large, heat reaches the boundary between an active material layer and a current collector such as a metal foil, adhesion between the active material layer and the current collector deteriorates. When the coating amount of the liquid is too small, sufficient heat cannot reach an active material layer, resulting in deterioration of adhesion between the active material layer and an electrolyte layer.

The heated liquid is preferably coated on the surface of the active material layer of an electrode material onto which heat-melted solid electrolyte is applied or on the surface of the solid electrolyte layer applied.

After the liquid in the invention has been coated on the active material layer to form a liquid layer, the heat-melted solid electrolyte can be applied to the liquid layer. In this case, adhesion between the solid electrolyte layer and the active material layer is more enhanced. The coated liquid is effective even when not heated, but is more effective in adhesion improvement, when heated than when not heated.

When the positive electrode and the negative electrode are combined with each other, an adhesion method carried out employing the heated liquid is effective as compared with that carried out employing a pair of heated rollers. The former not only heats the active material layer but also minimizes heat conduction to a current collector on which the active material layer is provided. Use of a current collector having a resin layer is advantageous in that deformation of the current collector due to heat application is minimized.

### [Shape of Battery]

The shape or external form of the battery in the invention is not specifically limited, but may be a conventional one. For example, the shape of the battery is such that a laminated electrode or roll electrode is housed in a metal or resin case or is sealed in a laminate film composed of a metal foil such as an aluminum foil and synthetic resin film. The external form of the battery is, for example, cylindrical, prismatic, coin-shaped or of lamination type. The form of the battery is preferably of lamination type in view of flexibility.

### [Lamination Type Secondary Battery]

In order to increase the battery capacity, lamination is preferably carried out after the battery is formed into roll or plural batteries are stacked. Lamination is more preferably carried out after plural batteries are stacked in view of flexibility.

As a process for manufacturing a laminate type secondary battery (hereinafter also referred to as a laminated secondary battery) in which plural batteries are stacked one on top of another and laminated, there is a process in which a positive electrode active material, a solid electrolyte layer, and a negative electrode active material are provided on both surfaces of a current collector and cut into an intended size to obtain a laminated material, and plural sheets of the laminated materials are stacked, connected to a positive electrode lead and a negative electrode lead, and then sealed in a laminate film. In the order of cutting and stacking, the laminated material may be cut one by one, followed by stacking the cut materials, or a specific amount of laminated materials may be stacked, followed by cutting. The cutting methods include conventional ones such as a slit cutting method, a guillotine cutting method and a roll cutting method, but are not limited thereto.

As a method of packing the laminated secondary battery, there is the following method. The laminated secondary battery is packed in laminated sheets composed of a non-breathable metal sheet and provided on one or both surfaces thereof, at least one insulating heat seal resin layer so that the resin layers of the laminated sheets face each other, and heat sealed in the periphery of the laminated sheets by application of heat or both pressure and heat, whereby the battery is tightly sealed.

The metal sheet constituting the laminated sheet is not specifically limited, as long as it can prevent moisture or oxygen outside the battery from permeating the battery and the solid electrolyte within the battery from leaking outside the battery. As metals for the metal sheet, a known metal such as aluminum, stainless steel, nickel or copper can be used. The thickness of the metal sheet is preferably from 10 to 150 μm, and more preferably from 30 to 100 μm. A metal sheet with too low thickness is insufficient in mechanical strength and in preventing moisture or oxygen outside the battery from permeating the battery, while a metal sheet with too high thickness, when heat sealed, cannot apply sufficient heat to the heat seal resin layer, which may result in deteriorating sealing reliability or battery energy density after heat sealing.

The insulating heat seal resin is not specifically limited, and a known insulating heat seal resin can be employed, as long as it can heat-seal the package of laminated sheet by heat sealing. Examples of the insulating heat seal resin include polyethylene, polypropylene, polyethylene terephthalate, polyimide, polymethyl methacrylate, an ionomer resin and a copolymer thereof. The thickness of the insulating heat seal resin layer is preferably from 20 to 100 μm, and more preferably from 30 to 80 μm. An insulating heat seal resin layer with too low thickness is insufficient in mechanical strength, while an insulating heat seal resin layer with too high thickness may result in deteriorating sealing reliability.

The packing employing laminated sheets provides a good gas barrier property and light shielding property, and is easy to heat seal.

The laminated sheet is preferably one in which the heat seal layer is provided on the surface of the metal sheet on the battery side and a resin with a strong mechanical property is provided on the surface of the metal sheet opposite the battery. Examples of the resin with a strong mechanical property include polyester such as polyethylene terephthalate and nylon such as nylon 66.

The laminated secondary battery may be square, rectangle, or in the form in which at least one corner of the four corners of the square or rectangle is a curve or is cut off.

### EXAMPLES

The present invention will be explained in detail in the following examples, but is not limited thereto. In the following examples, “parts” or “%” represents “parts by weight” or “% by weight”, unless otherwise specified.

### Examples 1 Through 6

### Preparation of Positive Electrode Active Material Layer Coating Liquid

Ninety four parts of lithium-cobalt compound oxide (LiCoO₂), 3 parts of graphite as a conductive material and 3 parts of polyvinylidene fluoride (PVdF) as a binder were uniformly mixed, and further added with N-methylpyrrolidone to obtain a positive electrode active material coating liquid.

### <Preparation of Negative Electrode Active Material Layer Coating Liquid>

Ninety seven parts of graphite and 3 parts of polyvinylidene fluoride (PVdF) as a binder were uniformly mixed, and further added with N-methylpyrrolidone to obtain a negative electrode active material coating liquid.

### <Preparation of Solid Electrolyte>

The following materials were mixed under a dry atmosphere with a moisture content of less than 5 ppm.

| | | |
|---|---|---|
| Ethylene Carbonate | 147 | g |
| Tetraglyme | 73 | g |
| LiCO₃ | 20 | g |

Subsequently, 7 g of the resulting mixture were mixed with 3 g of polyvinylidene chloride (Solef 1015 produced by Solvay Co., Ltd.), and heated to 150° C. The heated mixture was cooled to room temperature and molded into the shape of pellets. Thus, a solid electrolyte was prepared.

### <Liquid to be Heat-Coated on Active Material Layer>

### (Preparation of Liquid A)

The following materials were mixed under a dry atmosphere with a moisture content of less than 5 ppm.

| | | |
|---|---|---|
| Ethylene Carbonate | 147 | g |
| Tetraglyme | 73 | g |

Thus, the resulting liquid was designated as Liquid A. The liquid employed here was the same as the organic solvents employed in the preparation of the solid electrolyte above.

### (Preparation of Liquid B)

Dimethyl sulfoxide was designated as Liquid B. The liquid employed here was different from the organic solvents employed in the preparation of the solid electrolyte above.

<Coating of Positive and Negative Electrode Active Materials onto Current Collector>

Employing an extrusion coater, the positive electrode active material coating liquid obtained above was extrusion-coated onto one surface of an aluminum foil with a thickness of 20 μm as a first current collector (a current collector for positive electrode) to give a positive active material layer with a thickness of 120 μm, and dried through an infrared heater. Subsequently, the resulting positive active material layer was compressed through a compressor to give a thickness of 100 μm. Thus, a positive electrode was prepared.

Employing an extrusion coater, the negative electrode active material coating liquid obtained above was extrusion-coated onto one surface of a copper foil with a thickness of 20 μm as a second current collector (a current collector for negative electrode) to give a negative electrode active material layer with a thickness of 120 μm, and dried through an infrared heater. Subsequently, the resulting negative electrode active material layer was compressed through a compressor to give a thickness of 100 μm. Thus, a negative electrode was prepared.

### <Heat-Melt Coating of Solid Electrolyte>

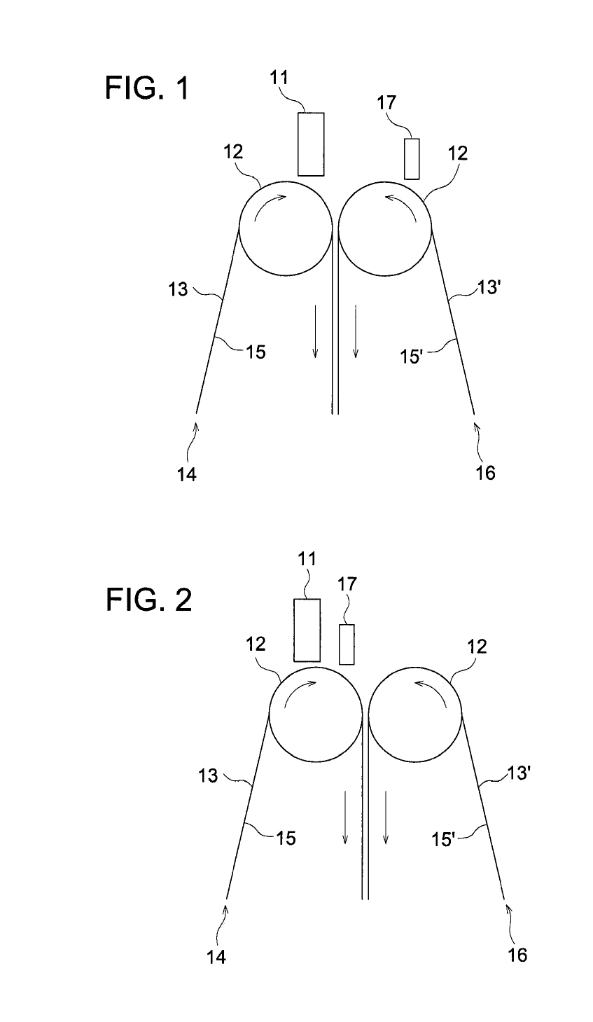

The solid electrolyte was heat melted at 150° C., and the heat melted solid electrolyte was coated onto the positive active material layer surface of the positive electrode through an extrusion coater to give a melted solid electrolyte layer with a thickness of 50 μm. Further, Liquid B, which had been heated at 150° C., was coated onto the negative electrode active material layer surface of the negative electrode to give a thickness of 5 g/m². Successively, the two coated materials prepared above were compression-adhered through rollers so that the melted solid electrolyte layer coated on the positive electrode active material layer faced the negative electrode active material layer of the negative electrode, and cooled to room temperature, whereby the melted solid electrolyte layer was solidified. Thus, a battery cell was obtained, in which the positive electrode and the negative electrode were combined with each other through the solid electrolyte layer. The resulting cell was enclosed in a bag and dried at 80° C. for 24 hours under vacuum. Herein, the bag was composed of a laminate film with a total thickness of 0.1 mm comprising an aluminum foil with a thickness of 40 μm and a polypropylene layer provided on both surface of the aluminum foil. The resulting cell was heat-sealed while maintaining at 80° C., and tightly sealed. Thus, a secondary battery 1 was prepared. The process for preparing the secondary battery 1 is shown in FIG. 1.

In FIG. 1, numerical numbers 11, 12, 13, 13′, 14, 15, 15′, 16 and 17 represent an extrusion coater for applying a solid electrolyte, a pair of pressure rollers, a positive electrode active material layer surface side, a negative electrode active material layer surface side, a positive electrode, a first current collector (a current collector for positive electrode), a second current collector (a current collector for negative electrode), a negative electrode, and a liquid applying coater, respectively. In FIG. 1, the positive electrode 14 is comprised of a first current collector 15 and provided thereon, a positive electrode active material layer, and the negative electrode 16 is comprised of a second current collector 15′ and provided thereon, a negative electrode active material layer. The solid electrolyte is heat melted and coated on the positive electrode active material layer surface side 13 of the positive electrode 14 through the extrusion coater 11 to form a heat-melted solid electrolyte layer and heated Liquid B is coated on the negative electrode active material layer surface side 13′ of the negative electrode 16 through the liquid applying coater 17 to form a liquid layer. The resulting coated materials are combined with each other through a pair of pressure rollers 12 so that the liquid layer faces the solid electrolyte layer.

### <Preparation of Secondary Batteries 2 Through 6>

Secondary battery 2 was prepared in the same manner as in secondary battery 1, except that Liquid A was employed instead of the Liquid B.

Secondary battery 3 was prepared in the same manner as in secondary battery 2, except that the Liquid A was coated on the solid electrolyte layer coated on the positive electrode active material layer surface and not on the negative electrode active material layer surface of the negative electrode. The process for preparing the secondary battery 3 is shown in FIG. 2.

In FIG. 2, numerical numbers 11, 12, 13, 13′, 14, 15, 15′, 16 and 17 represent the same as those denoted above in FIG. 1. The heat-melted solid electrolyte is coated on the positive electrode active material layer surface side 13 of the positive electrode 14 through the extrusion coater 11 to form a heat-melted solid electrolyte layer and then, heated Liquid A is coated on the resulting solid electrolyte layer through the liquid applying coater 17 to form a liquid layer. The resulting coated material and the negative electrode 16 are combined with each other through a pair of pressure rollers 12 so that the liquid layer faces the negative electrode active material layer surface side 13′.

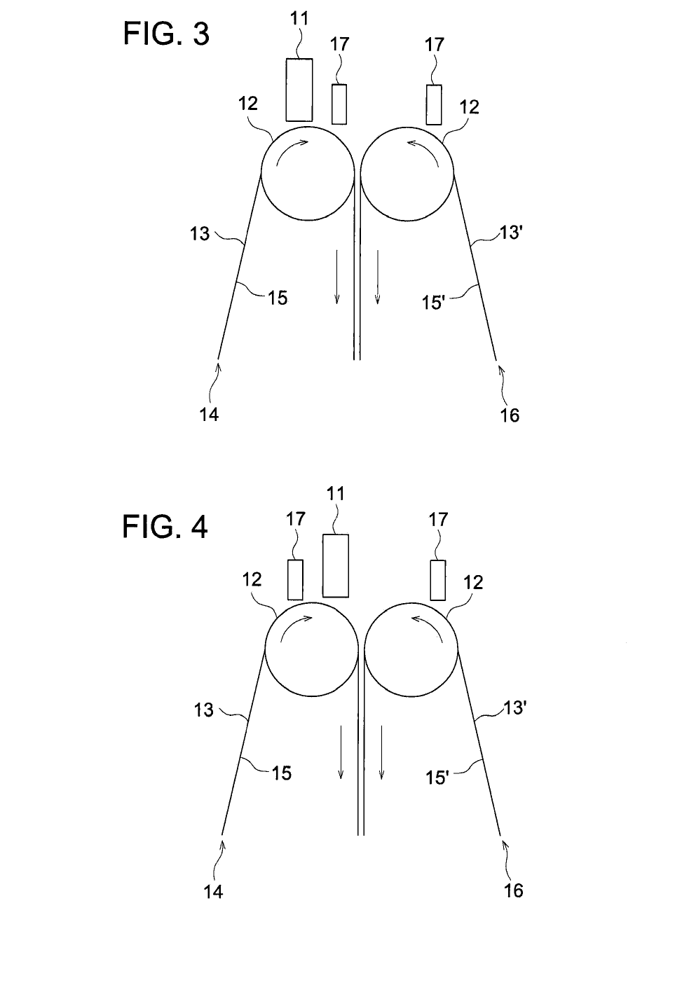

Secondary battery 4 was prepared in the same manner as in secondary battery 3, except that the heated Liquid A was further coated on the negative electrode active material layer of the negative electrode. The process for preparing the secondary battery 4 is shown in FIG. 3.

In FIG. 3, numerical numbers 11, 12, 13, 13′, 14, 15, 15′, 16 and 17 represent the same as those denoted above in FIG. 1. In FIG. 3, the heated Liquid A is further coated on the negative electrode active material layer side 13′ of the negative electrode 16 through the liquid applying coater 17 to form a liquid layer. The resulting coated materials are combined with each other through a pair of pressure rollers 12 so that both liquid layers formed face each other.

Secondary battery 5 was prepared in the same manner as in secondary battery 4, except that the heated Liquid A was coated on the positive electrode active material layer surface of the positive electrode to form a liquid layer, and then the heat-melted solid electrolyte was coated on the resulting liquid layer. The process for preparing the secondary battery 5 is shown in FIG. 4.

In FIG. 4, numerical numbers 11, 12, 13, 13′, 14, 15, 15′, 16 and 17 represent the same as those denoted above in FIG. 1. In FIG. 4, the heated Liquid A is coated on the positive electrode active material layer side 13 of the positive electrode 14 through the liquid applying coater 17 to form a first liquid layer, and then the heat-melted solid electrolyte is coated on the formed first liquid layer through the extrusion coater 11 to form a solid electrolyte layer. The heated Liquid A is coated on the negative electrode active material layer surface side 13′ of the negative electrode 16 through the liquid applying coater 17 to form a second liquid layer. The resulting coated materials are combined with each other through a pair of pressure rollers 12 so that the second liquid layer formed faces the solid electrolyte layer.

Secondary battery 6 was prepared in the same manner as in secondary battery 5, except that an aluminum foil/PET laminate in which a 15 μm thick aluminum foil was laminated on a 15 μm thick PET film was employed as the first current collector of the positive electrode instead of the 20 μm thick aluminum foil aluminum foil, and a copper foil/PET laminate in which a 15 μm thick copper foil was laminated on a 15 μm thick PET film was employed as the second current collector of the negative electrode instead of the 20 μm thick copper foil.

### Comparative Examples 1 and 2

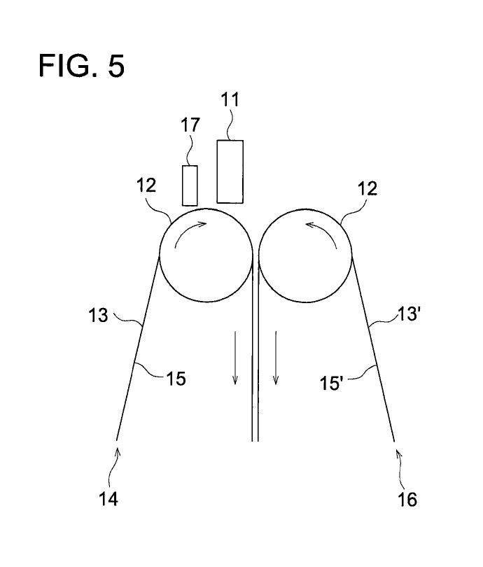

Secondary battery 7 was prepared in the same manner as in secondary battery 5, except that the heated Liquid B was not coated onto the negative electrode active material layer surface of the negative electrode, and the negative and positive electrodes were directly compression-adhered through a pair of heated pressure rollers so that the solid electrolyte layer surface of the positive electrode faces the negative electrode active material layer surface of the negative electrode. The process for preparing the secondary battery 7 is shown in FIG. 5.

In FIG. 5, numerical numbers 11, 12, 13, 13′, 14, 15, 15′, 16 and 17 represent the same as those denoted above in FIG. 1. In FIG. 5, the heated Liquid A is coated on the positive electrode active material layer side 13 of the positive electrode 14 through the liquid applying coater 17 to form a liquid layer and then the heat-melted solid electrolyte is coated on the formed liquid layer through the extrusion coater 11 to form a solid electrolyte layer. The resulting solid electrolyte layer formed on the positive electrode active material layer side 13 is directly combined with the negative electrode active material layer 13′ of the negative electrode 16 through a pair of pressure rollers 12 heated at 150° C.

Secondary battery 8 was prepared in the same manner as in secondary battery 7, except that a pair of unheated pressure rollers were employed instead of a pair of the heated pressure rollers.

### (Evaluation)

### [Repeated Charge/Discharge Cycle Property]

Ten specimens of each of the batteries prepared above were prepared. Each specimen was charged at 25° C. to an upper-limited voltage of 4.2 V at a constant electric current of C/2 and discharged at 25° C. to a lower-limited voltage of 2.5 V at a constant electric current of C/2. This charge/discharge cycle was repeated 10 times and 100 times. The ratio of the first discharge amount to the tenth and the ratio of the first discharge amount to one hundredth discharge amount were determined in terms of t. Those ratios of ten specimens of each battery were determined, and an average thereof was employed for evaluation. Herein, 1C refers to an electric current amount necessary to charge, in one hour, the capacity computed from the amount of the positive electrode active material in each battery.

The results are shown in Table 1.

TABLE 1

| | | Repeated | | |
|---|---|---|---|---|
| | Secondary | charge/discharge cycle | | |
| | battery Nos. | property | | Re- |
| | employed | (i) | (ii) | marks |
| Ex. 1 | 1 | 90 | 83 | Inv. |
| Ex. 2 | 2 | 94 | 88 | Inv. |
| Ex. 3 | 3 | 95 | 88 | Inv. |
| Ex. 4 | 4 | 95 | 88 | Inv. |
| Ex. 5 | 5 | 95 | 91 | Inv. |
| Ex. 6 | 6 | 97 | 94 | Inv. |
| Comp. Ex. 1 | 7 | 87 | 71 | Comp. |
| Comp. Ex. 2 | 8 | 84 | 71 | Comp. |

Ex.: Example, Comp. Ex.: Comparative Example
Inv.: Inventive, Comp: Comparative
(i) Ratio (%) of first discharge amount to tenth discharge amount
(ii) Ratio (%) of first discharge amount to one hundredth discharge amount

As is apparent from Table 1, secondary battery Nos. 7 and 8 (comparative) are weak in adhesion between the solid electrolyte layer and the electrodes, and particularly when 100 charge/discharge cycles are repeated, greatly reduces the discharge amount, resulting in poor repeated charge/discharge cycle property, particularly when 100 charge/discharge cycles are repeated. On the other hand, the inventive secondary battery Nos. 1 through 6 have a good adhesion between the solid electrolyte layer and the electrodes, and minimize reduction of the discharge amount even when charge/discharge cycles are repeated. That is, according to the process of the present invention, a secondary battery having excellent charge/discharge cycle property and high capacity can be manufactured at high productivity.

What is claimed is:

1. A process for manufacturing a secondary battery comprising a positive electrode, a negative electrode and a solid electrolyte layer, the positive electrode comprising a first current collector and provided thereon, a positive electrode active material layer containing a positive electrode active material, the negative electrode comprising a second current collector and provided thereon, a negative electrode active material layer containing a negative electrode active material, and the solid electrolyte layer being interposed between the positive electrode active material layer and the negative electrode active material layer, the process comprising the steps of:
a) heat-melting a solid electrolyte;
b) coating the heat-melted solid electrolyte on a first layer which is one layer of the positive electrode active material layer of the positive electrode and the negative electrode active material layer of the negative electrode, thereby forming a solid electrolyte layer; and
c) combining the solid electrolyte layer with a second layer which is the other layer of the positive electrode active material layer of the positive electrode and the negative electrode active material layer of the negative electrode, through a heated liquid.

2. The process for manufacturing a secondary battery of claim 1, wherein the heated liquid is coated on the second layer.

3. The process for manufacturing a secondary battery of claim 2, wherein the coating amount of the heated liquid is from 1 to 50 g/m².

4. The process for manufacturing a secondary battery of claim 1, wherein the heated liquid is coated on the solid electrolyte layer.

5. The process for manufacturing a secondary battery of claim 4, wherein the coating amount of the heated liquid is from 1 to 50 g/m².

6. The process for manufacturing a secondary battery of claim 1, wherein the solid electrolyte is heat-melted at 100 to 200° C., and the heated liquid is one heated at 100 to 200° C.

7. The process for manufacturing a secondary battery of claim 1, wherein the solid electrolyte layer contains a polymer compound, an organic solvent and a lithium salt.

8. The process for manufacturing a secondary battery of claim 7, wherein the organic solvent contained in the solid electrolyte layer is the same as an organic solvent contained in the heated liquid.

9. The process for manufacturing a secondary battery of claim 1, wherein the positive electrode active material is selected from the group consisting of lithium manganese compound oxide (LiₓMn₂O₄), lithium nickel compound oxide (LiₓNiO₂), lithium cobalt compound oxide (LiₓCoO₂), lithium nickel cobalt compound oxide (LiₓNi_{1-y}Co_{y}O₂), spinel type lithium manganese nickel compound oxide (LiₓMn_{2-y}Ni_{y}O₄) lithium manganese cobalt compound oxide (LiₓMn_{y}Co_{1-y}O₂) and lithium iron phosphate (LiₓFePO₄), wherein x and y independently are in the range of from 0 to 1, and the negative electrode active material is a carbonaceous material selected from the group consisting of non-graphitizable carbon, graphitizable carbon, graphite, cracked carbon, cokes, glassy carbon, organic polymer compound calcined materials, carbon fiber and activated carbon.

10. The process for manufacturing a secondary battery of claim 1, wherein the first current collector comprises a metal foil and provided thereon, a resin layer, the resin layer being provided on the surface of the first current collector opposite the positive electrode active material layer, or wherein the second current collector comprises a metal foil and provided thereon, a resin layer, the resin layer being provided on the surface of the second current collector opposite the negative electrode active material layer.

11. A process for manufacturing a secondary battery comprising a positive electrode, a negative electrode and a solid electrolyte layer, the positive electrode comprising a first current collector and provided thereon, a positive electrode active material layer containing a positive electrode active material, the negative electrode comprising a second current collector and provided thereon, a negative electrode active material layer containing a negative electrode active material, and the solid electrolyte layer being interposed between the positive electrode active material layer and the negative electrode active material layer, the process comprising the steps of:
a) heat-melting a solid electrolyte;
b) coating a first heated liquid on a first layer which is one layer of the positive electrode active material layer of the positive electrode and the negative electrode active material layer of the negative electrode, thereby forming a first heated liquid layer;
c) coating a second heated liquid on a second layer which is the other layer of the positive electrode active material layer of the positive electrode and the negative electrode active material layer of the negative electrode, thereby forming a second heated liquid layer;
d) coating the heat melted solid electrolyte on the first liquid layer, thereby forming an solid electrolyte layer; and
e) combining the solid electrolyte layer with the second layer through the second heated liquid layer.

12. The process for manufacturing a secondary battery of claim 11, wherein the coating amount of the first and second heated liquids is from 1 to 50 g/m².

13. The process for manufacturing a secondary battery of claim 11, wherein the solid electrolyte is heat-melted at 100 to 200° C., and the first and second heated liquids are ones heated at 100 to 200° C.

14. The process for manufacturing a secondary battery of claim 11, wherein the solid electrolyte layer contains a polymer compound, an organic solvent and a lithium salt.

15. The process for manufacturing a secondary battery of claim 14, wherein the organic solvent contained in the solid electrolyte layer is the same as an organic solvent contained in the second heated liquid.

16. The process for manufacturing a secondary battery of claim 11, wherein the positive electrode active material is selected from the group consisting of lithium manganese compound oxide (LiₓMn₂O₄), lithium nickel compound oxide (LiₓNiO₂), lithium cobalt compound oxide (LiₓCoO₂), lithium nickel cobalt compound oxide (LiₓNi_{1-y}Co_{y}O₂), spinel type lithium manganese nickel compound oxide (LiₓMn_{2-y}Ni_{y}O₄), lithium manganese cobalt compound oxide (LiₓMn_{y}Co_{1-y}O₂), or lithium iron phosphate (LiₓFePO₄), wherein x and y independently are in the range of from 0 to 1, and the negative electrode active material is a carbonaceous material selected from the group consisting of non-graphitizable carbon, graphitizable carbon, graphite, cracked carbon, cokes, glassy carbon, organic polymer compound calcined materials, carbon fiber and activated carbon.

17. The process for manufacturing a secondary battery of claim 11, wherein the first current collector comprises a metal foil and provided thereon, a resin layer, the resin layer being provided on the surface of the first current collector opposite the positive electrode active material layer, or wherein the second current collector comprises a metal foil and provided thereon, a resin layer, the resin layer being provided on the surface of the second current collector opposite the negative electrode active material layer.
